(19) United States
(12) Patent Application Publication
(10) Pub. No.: US 2025/0091126 A1
(43) Pub. Date: Mar. 20, 2025

(54) MAGNETIC COMPONENT OF POWER INDUCTOR AND FABRICATION METHOD THEREOF

(71) Applicant: Cyntec Co., Ltd., Hsinchu (TW)

(72) Inventors: Chih Hung Wei, Hsinchu (TW); Chung Kai Liao, Hsinchu (TW)

(21) Appl. No.: 18/964,226

(22) Filed: Nov. 29, 2024

Related U.S. Application Data
(63) Continuation of application No. 17/720,278, filed on Apr. 13, 2022.
(60) Provisional application No. 63/174,551, filed on Apr. 14, 2021.

(51) Int. Cl. B22F 1/00; B22F 1/052; B22F 1/14; B22F 1/16; B22F 3/10; H01F 1/153; H01F 27/02; H01F 27/24; H01F 27/28; H01F 27/32; H01F 41/04; H01F 41/12

(52) U.S. Cl. CPC B22F 1/09; B22F 1/052; B22F 1/14; B22F 1/16; B22F 3/1007; H01F 1/153; H01F 27/022; H01F 27/24; H01F 27/2804; H01F 27/323; H01F 41/042; H01F 41/122; B22F 2301/35; B22F 2302/25; B22F 2302/45; B22F 2304/10; H01F 2027/2809

(57) ABSTRACT

A magnetic component is adapted to be used in a power inductor. The magnetic component includes a magnetic body containing amorphous magnetic powders and/or nano-crystalline magnetic powders and at least one silicon-free glass material distributed among the amorphous magnetic powders and/or nano-crystalline magnetic powders; a coil embedded in the magnetic body; and a pair of electrodes electrically connected to two terminals of the coil, respectively.

### CROSS-REFERENCES TO RELATED APPLICATIONS

This application is a continuation-in-part application and claims the benefit of U.S. patent application Ser. No. 17/720,278 filed on Apr. 13, 2022, which further claims the benefit of U.S. Provisional Patent Application No. 63/174,551 filed on Apr. 14, 2021. Both are incorporated by reference herein and made a part of the specification.

### FIELD OF THE INVENTION

The present invention relates to a magnetic component, and more particularly to a magnetic component adapted to be used in a power inductor. The present invention also relates to a fabrication method of a magnetic component adapted to be used in a power inductor.

### BACKGROUND OF THE INVENTION

In recent years, with the development of portable information electronic products and mobile communication products towards miniaturization and multifunction, components operating under different voltage requirements, e.g., LCD screen, wireless communication module, baseband module and/or camera module, are integrated into one product. As a result, a battery applicable to a wide range of voltage is needed in order to covert the voltage of the battery into the voltages required by the various added components. Meanwhile, the demand on conversion circuitry or DC to DC converter is increasing. In response to this demand, a multilayer power inductor which is capable of enhancing the conversion efficiency of power supply becomes more and more important in relevant applications.

A conventional multilayer power inductor is made of a magnetic material. In a sintering process at a high temperature higher than 700° C., oxides are generated on surfaces of magnetic powders, and the magnetic powders are bonded together by way of diffusion of magnetic powders. Since powders are usually accumulated densely so as to be in close bonded with one another, oxidation cannot be evenly performed on all the powder surfaces. Therefore, improvement on the insulation impedance of the multilayer power inductor is limited. Moreover, the crystalline state of magnetic powders is likely to change in the high-temperature sintering process, and thus the resulting inductance property might be deteriorated.

Generally speaking, a multilayer power inductor made of the sintered magnetic powders has moderate magnetic permeability. However, core loss of the sintered magnetic powders is relatively high, so conversion efficiency of the conversion circuitry or DC-DC converters might be deteriorated. Furthermore, since the sintering temperature needs to be above 700° C. in order to bond the magnetic powders together by grain-boundary diffusion and achieve the effect of high density, the crystalline state of the multilayer power inductor would be changed and the inductance property would become unsatisfactory.

### SUMMARY OF THE INVENTION

Therefore, the present invention provides a magnetic component adapted to be used in a power inductor. The magnetic component can be formed at a lower co-firing temperature while having properties of reduced core loss, satisfactory insulation impedance and inductance, as well as improved co-firing effects.

The present invention also provides a fabrication method of a magnetic component adapted to be used in a power inductor or single-layer power inductor. The fabrication method involves a co-firing temperature lower than 500° C. while producing a magnetic component having properties of reduced core loss, satisfactory insulation impedance and inductance, as well as improved co-firing effects.

In an aspect of the present invention, a magnetic component adapted to be used in a power inductor or single-layer power inductor comprises a magnetic body or single-layer magnetic body comprising amorphous magnetic powders and/or nano-crystalline magnetic powders and at least one silicon-free glass material distributed among the amorphous magnetic powders and/or nano-crystalline magnetic powders; a coil; and a pair of electrodes electrically connected to two terminals of the coil, respectively.

In another aspect of the present invention, a fabrication method of a magnetic component comprises: forming a magnetic body containing amorphous magnetic powders and/or nano-crystalline magnetic powders and at least one silicon-free glass material distributed among the amorphous magnetic powders and/or nano-crystalline magnetic powders; forming a coil; and forming a pair of electrodes electrically connected to two terminals of the coil, respectively.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic diagram illustrating a magnetic component according to an embodiment of the present invention;

FIG. 1B is a schematic cross-sectional diagram illustrating a magnetic body included in a magnetic component according to an embodiment of the present invention;

FIG. 1C is a schematic cross-sectional diagram illustrating a magnetic body included in a magnetic component according to another embodiment of the present invention;

FIG. 2A is a schematic cross-sectional view taken along the A-A′ line shown in FIG. 1A, which illustrates a coil included in a magnetic component and embedded in a magnetic body of the magnetic component according to an embodiment of the present invention;

FIG. 2B is a schematic diagram illustrating top views of layers included in the coil shown in FIG. 2A;

FIG. 2C is a schematic cross-sectional view taken along the B—B′ line in one of the layers shown in FIG. 2B;

FIG. 3 is a plot exemplifying a particle size distribution of amorphous magnetic powders and/or nano-crystalline magnetic powders included in a magnetic body of a magnetic component according to an embodiment of the present invention;

FIG. 4 is a scheme illustrating formation of a magnetic body included in a magnetic component according to an embodiment of the present invention;

FIG. 5 is a scheme illustrating mechanical fusing of medium powders onto at least partial surface area of amorphous magnetic powders and/or nano-crystalline magnetic powders according to an embodiment of the present invention;

FIG. 6 is a scheme illustrating formation of a magnetic body included in a magnetic component according to another embodiment of the present invention;

FIG. 7 is a scheme illustrating formation of a magnetic body included in a magnetic component according to a further embodiment of the present invention;

FIG. 8 is a scheme illustrating formation of a magnetic body included in a magnetic component according to still another embodiment of the present invention; and

FIG. 9 is a schematic diagram illustrating a magnetic component according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

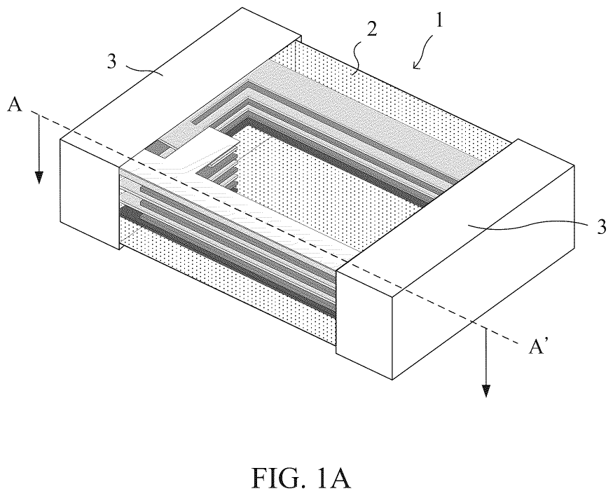

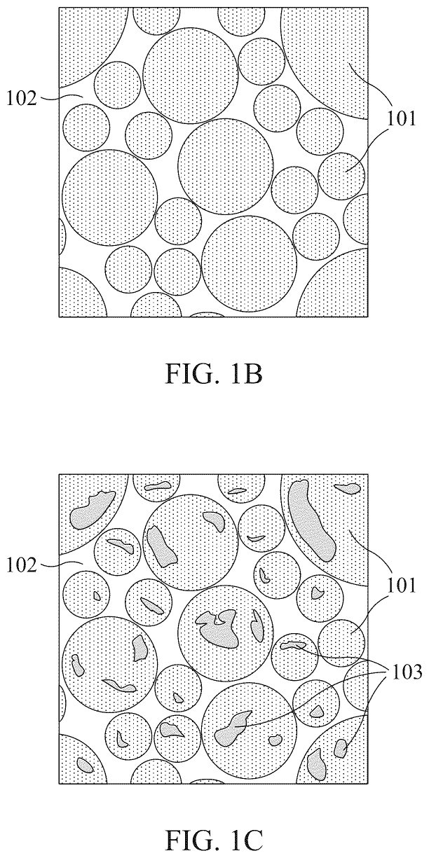

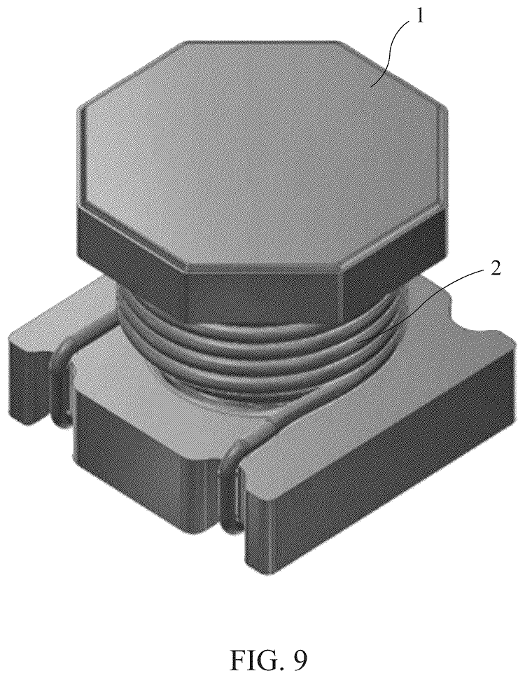

Please refer to FIG. 1A, in which a magnetic component according to an embodiment of the present invention is schematically illustrated. The magnetic component is adapted to be used in a multilayer power inductor, and includes a magnetic body 1, a coil 2 and a pair of electrodes 3. It is to be noted that in the embodiment illustrated in FIG. 1A, a multilayer magnetic body 1 is comprised in the magnetic component as an example, but it is not limited thereto. Alternatively, the magnetic body may also be a non-multilayer one, as illustrated in FIG. 9. Furthermore, in FIG. 1A, the multilayer magnetic body 1 is depicted in a transparent manner for making the configuration of the layout of the coil 2 visible, and the coil 2 is actually embedded in the magnetic body 1. The magnetic body 1 includes amorphous magnetic powders and/or nano-crystalline magnetic powders 101 and at least one glass material 102 distributed among the amorphous magnetic powders and/or nano-crystalline magnetic powders 101 for binding the amorphous magnetic powders and/or nano-crystalline magnetic powders 101 together, as shown in FIG. 1B. In an embodiment, the amorphous magnetic powders and/or nano-crystalline magnetic powders 101 include, for example, iron-based powders which are formed of an alloy containing at least elements Fe, Cr, Si, B and C. In another embodiment, the iron-based powders included in the amorphous magnetic powders and/or nano-crystalline magnetic powders are at least partially formed with an oxide material 103 on surfaces thereof, as shown in FIG. 1C.

For achieving the objective of forming the magnetic component at a lower temperature without deteriorating co-firing effects, the glass material 102 in the embodiments according to the present invention is selected to comprise a silicon-free glass material. Examples of the silicon-free glass material include, but are not limited to, SnO—P₂O₅, V₂O₅—TeO₂, Bi₂O₃—B₂O₃, ZnO, or A₂O—MoO₃ system, where A is an alkali metal or silver. Preferably, the silicon-free glass material is SnO—P₂O₅, V₂O₅—TeO₂, Bi₂O₃—B₂O₃ or A₂O—MoO₃ system. The silicon-free glass material comprises glass powders, whose average particle size D₅₀ is less than 1 μm. The softening point of the silicon-free glass material is about 300° C.˜430° C. For example, the softening point of SnO—P₂O₅ system is about 340° C.˜400° C.; the softening point of V₂O₅—TeO₂ system is about 320° C.˜350° C.; and the softening point of Bi₂O₃—B₂O₃ or ZnO system is about 400° C.˜430° C. With the silicon-free glass powders, diffusion of the amorphous magnetic powders and/or nano-crystalline magnetic powders can be avoided, and so does grain growth of the amorphous magnetic powders and/or nano-crystalline magnetic powders, i.e., conversion from amorphous or nano-crystalline into crystalline. The silicon-free glass material 102 in the magnetic body 1 is about 8 vol % or less of the amorphous magnetic powders and/or nano-crystalline magnetic powders 101 in the magnetic body 1 so that the gaps among the amorphous magnetic powders and/or nano-crystalline magnetic powders 101 would be desirably reduced. As a result, the magnetic flux density and the inductance of the power inductor can be maintained.

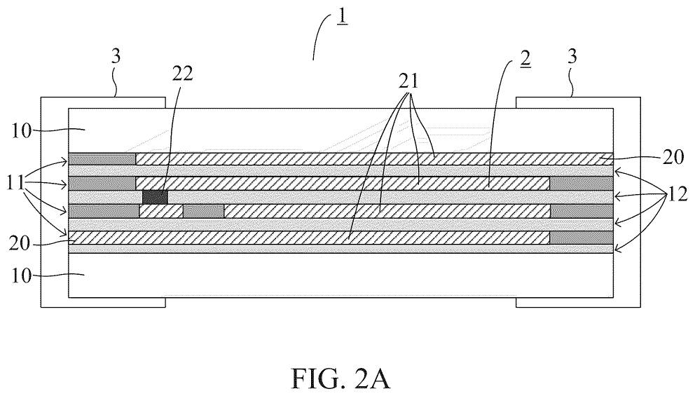

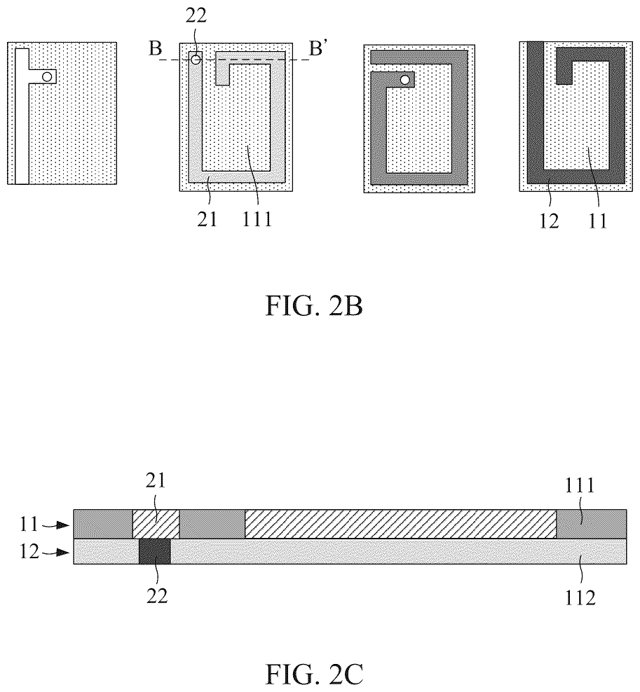

FIG. 2A is a schematic cross-sectional view taken along the A-A′ line of FIG. 1A, in which partial layers of the magnetic body 1 are shown. In FIG. 2A, a coil included in an embodiment of the magnetic component according to the present invention is illustrated. The coil 2 is embedded in the multilayer magnetic body 1, and electrodes 3 are electrically connected to two terminals 20 of the coil 2, as exemplified in FIG. 2A. As shown, the coil 2 comprises a plurality of wiring layers 21 connected to each other by a plurality of via layers 22. The wiring layers 21 are embedded in a first portion 11 of the magnetic body 1, and the via layers 22 are embedded in a second portion 12 of the multilayer magnetic body 1 The magnetic body 1 and the coil 2 are accommodated between upper and lower magnetic covers 10. Referring to FIG. 2B, expanded top views of the four wiring layers 21 of the coil 2 as shown in FIG. 2A are illustrated. Each of the wiring layers 21 includes a conductive pattern formed of a conductive material, e.g., atomized silver, and each of the via layers 22 includes a via pattern formed of a conductive material, which is preferably but not necessarily the same conductive material, e.g., atomized silver, or any other suitable material.

The first portion 11 of the magnetic body 1 in this embodiment is multilayered so as to consist of a plurality of first magnetic layers. In the first portion 11, the plurality of wiring layers are embedded. The first magnetic layers are defined as wiring pattern layers 111 of the coil 2. On the other hand, the second portion 12 of the magnetic body 1 is multilayered so as to include a plurality of second magnetic layers. In the second portion 12, the plurality of via layers are embedded. The second magnetic layers are defined as spacing pattern layers 112 between two wiring pattern layers 111. The wiring pattern layers 111 and the spacing pattern layers 112, as partially illustrated in the schematic cross-sectional diagram of FIG. 2C, which is taken along the B—B′ line of FIG. 2B. may have different compositions, particle size distributions, layer thickness, or other required parameters. It is to be noted that all the parameters are not required to be different. Instead, the parameters may be different in only some of them. Examples will be given as follows.

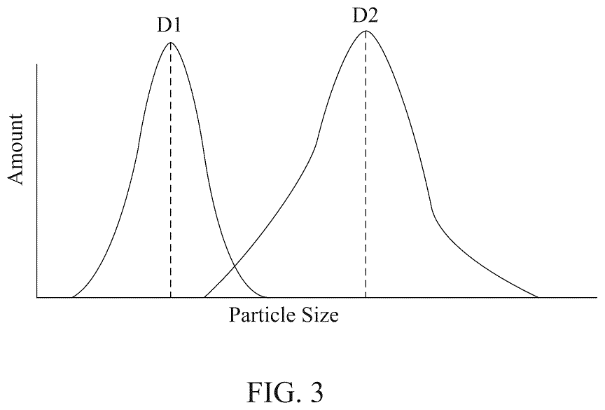

For example, in some embodiments, the amorphous magnetic powders and/or nano-crystalline magnetic powders contained in the wiring pattern layer 111 have at least a first diameter distribution peak at a first diameter D1 and a second diameter distribution peak at a second diameter D2 greater than the first diameter D1, as exemplified with reference to FIG. 3. In an embodiment, the first diameter D1 is about 1-2 μm, and the second diameter D2 is 10-20 times of the first diameter D1 for balance between structural strength and insulation effect. The bigger powders, if not big enough, might deteriorate the strength after co-firing, while the bigger powders, if too big, might deteriorate the insulating impedance. Furthermore, the smaller powders facilitate improvement of weathering resistance. The different sizes of powders may attribute to different kinds of amorphous magnetic powders and/or nano-crystalline magnetic powders, which are selected from, for example, Fe—Si—B—C—Cr alloy with D₅₀=29 μm (denoted as U herein), Fe—Si—B—C—Cr alloy with D₅₀=16 μm (denoted as X herein), Fe—Si—B—C—Cr—Ni alloy with D₅₀=9.9 μm (denoted as Z herein) and Fe—Si—B—C—Cr—Ni—P alloy with D₅₀=1 μm (denoted as P herein). On the other hand, the amorphous magnetic powders and/or nano-crystalline magnetic powders contained in the spacing pattern layer 112 have a single diameter distribution peak at another diameter D3, which is about 1˜5 μm. In another aspect, an average particle size D₅₀ of the amorphous magnetic powders and/or nano-crystalline magnetic powders in the wiring pattern layer 111 is greater than an average particle size D₅₀ of the amorphous magnetic powders and/or nano-crystalline magnetic powders in the spacing pattern layer 112. In an embodiment, the average particle size D₅₀ of the amorphous magnetic powders and/or nano-crystalline magnetic powders in the wiring pattern layer 111 is about 5.2˜20 μm, and the average particle size D₅₀ of the amorphous magnetic powders and/or nano-crystalline magnetic powders in the spacing pattern layer 112 is about 1˜5 μm. In a further aspect, the wiring pattern layer 111 includes has a thickness greater than a thickness of the spacing pattern layer 112. In an embodiment, the thickness of the spacing pattern layer 112 is 5˜10 μm, and the thickness of the wiring pattern layer is about 20-40 μm. In addition to the different parameters exemplified above, other parameters, e.g., material or appearance, may also be considered as design options to improve relative permeability, insulation properties and mechanical strength, and meanwhile, to reduce overall thickness of the magnet body or inductor structure.

Therefore, in a fabrication method of the magnetic component according to the present invention, a magnetic body 1 comprising amorphous magnetic powders and/or nano-crystalline magnetic powders and at least one silicon-free glass material distributed among the amorphous magnetic powders and/or nano-crystalline magnetic powders are formed, and a coil 2 is formed in the magnetic body 1. Subsequently, a pair of electrodes 3 electrically connected to two terminals 20 of the coil 2, respectively. The coil 2 is formed by embedding a plurality of wiring layers 21 in the wiring pattern layers 111 and a plurality of via layers 22 in the spacing pattern layers 112 before laminating the wiring pattern layers 111 and the spacing pattern layers 112. Desirably but not necessarily, the wiring pattern layer 111 and the spacing pattern layer 112 may be formed by the same or similar method.

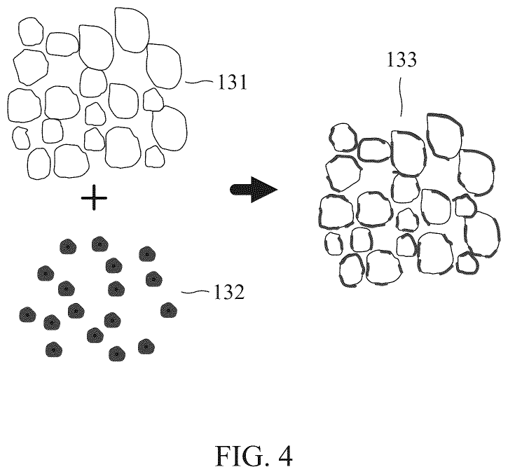

Hereinafter, methods of forming a magnetic body, which may be a multilayer or non-multilayer magnetic body, according to embodiments of the present invention will be described with reference to FIGS. 4-8.

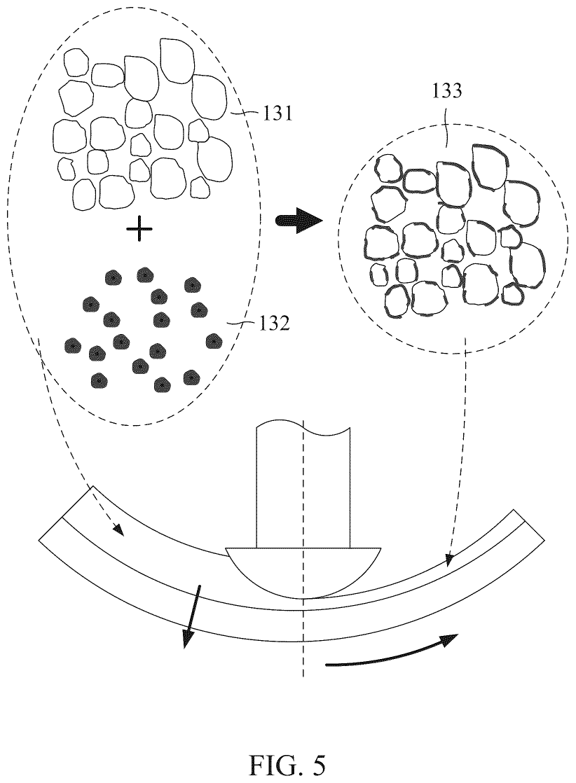

Please refer to FIG. 4, which schematically illustrates formation of a magnetic body included in a magnetic component according to an embodiment of the present invention. In this embodiment, amorphous magnetic powders and/or nano-crystalline magnetic powders 131 are formed of an iron-based alloy comprising elements of Fe, Cr, Si, B and C and further processed by applying medium powders 132 onto at least partial surface area of the amorphous magnetic powders and/or nano-crystalline magnetic powders 131, thereby obtaining the amorphous magnetic powders and/or nano-crystalline magnetic powders 133. For example, the medium powders 132 can be applied onto the surface area of the amorphous magnetic powders and/or nano-crystalline magnetic powders 131 by mechanical fusing as illustrated in FIG. 5. The press head or rotor moves back and forth while rotating to exert pressure forces on the magnetic powders 131 and the insulating oxide powders 132, causing the insulating oxide powders 132 (or the glass material) to deform and adhere to the outer surfaces of the magnetic powders 131. The magnetic powders 133 can be used as the amorphous magnetic powders and/or nano-crystalline magnetic powders 101 illustrated in FIG. 1B, and they are processed by a co-firing process at a co-firing temperature, e.g., 470˜500° C., which is higher than the softening point of the silicon-free glass powders. The medium powders 132 having a particle size smaller than that of the amorphous magnetic powders and/or nano-crystalline magnetic powders 131 may be glass powders or/and insulating oxide powders. When insulating oxide powders are mechanically fused onto partial area of the amorphous magnetic powders and/or nano-crystalline magnetic powders 131, the average diameter D₅₀ of the insulating oxide powders is at least 10 times smaller than that of amorphous magnetic powders and/or nano-crystalline magnetic powders 131, and preferably less than 0.1 μm. The insulating oxide powders 132 in the magnetic body 1 is about 2.5 vol % (volume percentage) or less of the amorphous magnetic powders and/or nano-crystalline magnetic powders 131 in the magnetic body 1 so that the gaps among the amorphous magnetic powders and/or nano-crystalline magnetic powders 131 would be desirably reduced. The material of the insulating oxide powders may be oxide of, for example, magnesium, titanium, zinc, silicon or aluminum (MgO, TiO₂, ZnO, SiO₂, Al₂O₃), and more preferable, may be oxide of, for example, magnesium, titanium or zinc (MgO, TiO₂, ZnO). When glass powders are mechanically fused onto partial area of the amorphous magnetic powders and/or nano-crystalline magnetic powders 131, the material of the glass powders may be the same as or different from the material of the silicon-free glass 102 illustrated in FIG. 1B. The amorphous magnetic powders and/or nano-crystalline magnetic powders 133 serving as the amorphous magnetic powders and/or nano-crystalline magnetic powders 101 illustrated in FIG. 1B are then cofired with the silicon-free glass powders 102 at a proper temperature, which can facilitate bonding but does not change the non-bonding state of the amorphous magnetic powders and/or nano-crystalline magnetic powders 101. For example, the temperature is 50° C. higher than the softening point of the silicon-free glass powders 102, and 500° C. lower than the crystallization temperature of the amorphous magnetic powders and/or nano-crystalline magnetic powders 101. The magnetic body produced accordingly may serve as the wiring pattern layer 111 or the spacing pattern layer 112, depending on the material and diameter distribution of the amorphous magnetic powders and/or nano-crystalline magnetic powders 111.

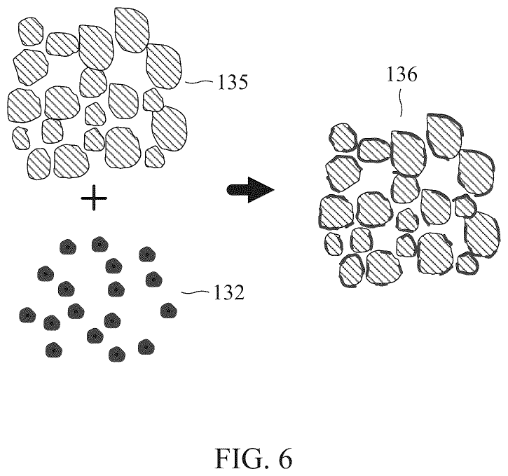

Please refer to FIG. 6, which schematically illustrates formation of a magnetic body included in a magnetic component according to another embodiment of the present invention. This embodiment is similar to the embodiment described above with reference to FIG. 4 or FIG. 5 except that amorphous magnetic powders and/or nano-crystalline magnetic powders 135 is used in lieu of the amorphous magnetic powders and/or nano-crystalline magnetic powders 131, and the medium powders 132 are glass powders. The amorphous magnetic powders and/or nano-crystalline magnetic powders 135 are at least partially oxidized amorphous magnetic powders and/or nano-crystalline magnetic powders. The medium powders 132 are then mechanically fused onto the at least partially oxidized amorphous magnetic powders and/or nano-crystalline magnetic powders 135 to produce amorphous magnetic powders and/or nano-crystalline magnetic powders 136 with deformed medium powders 132 applied thereon, which are used as the amorphous magnetic powders and/or nano-crystalline magnetic powders 101 illustrated in FIG. 1B. The amorphous magnetic powders and/or nano-crystalline magnetic powders 136 serving as the amorphous magnetic powders and/or nano-crystalline magnetic powders 101 illustrated in FIG. 1B are then cofired with the silicon-free glass powders 102 at a proper temperature to produce the magnetic body used as the wiring pattern layer 111 or the spacing pattern layer 112.

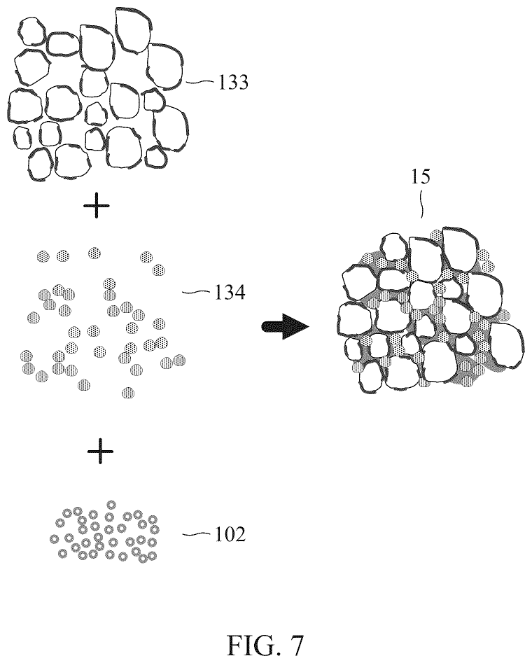

Please refer to FIG. 7, which schematically illustrate formation of a multilayer magnetic body included in a magnetic component according to a further embodiment of the present invention. In this embodiment, insulating oxide powders 134 are added to the amorphous magnetic powders and/or nano-crystalline magnetic powders 133 produced in the embodiment illustrated in FIG. 4 to further improve insulating impedance. Preferably, the insulating oxide powders 134 have an average particle size D₅₀ less than one tens of an average particle size D₅₀ of the amorphous magnetic powders and/or nano-crystalline magnetic powders 133. The average particle size D₅₀ of the insulating oxide powders 134 or/and silicon-free glass material 102 is less than 0.1 μm. In an embodiment, the insulating oxide powders 134 are oxidized from a material different from a material of the amorphous magnetic powders and/or nano-crystalline magnetic powders 133, and adhered onto the amorphous magnetic powders and/or nano-crystalline magnetic powders 133 by way of the silicon-free glass material 102. For example, the insulating oxide powders 134 are oxidized from magnesium, titanium, zinc, silicon or aluminum. The insulating oxide powders 134 in the multilayer magnetic body 1 is about 2.5 vol % or less of the amorphous magnetic powders and/or nano-crystalline magnetic powders 133 in the magnetic body 1. In this embodiment, a magnetic body material 15 comprising amorphous magnetic powders and/or nano-crystalline magnetic powders 133, which comprise amorphous magnetic powders and/or nano-crystalline magnetic powders formed of iron-based alloy and mechanically fused medium powders 132, insulating oxide powders 134 and silicon-free glass material 102, is produced. After a co-firing process, the magnetic body material 15 can be formed into a magnetic body, e.g., the magnetic body 1 shown in FIG. 1A.

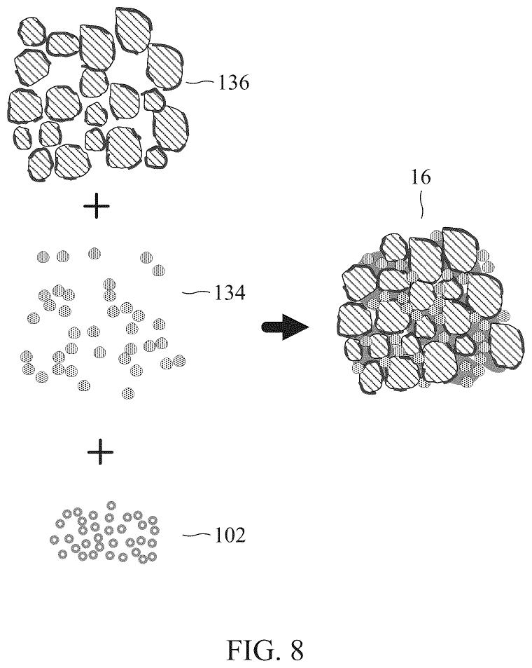

Please refer to FIG. 8, which schematically illustrate formation of a magnetic body included in a magnetic component according to still another embodiment of the present invention. This embodiment is similar to the embodiment described above with reference to FIG. 7 except that amorphous magnetic powders and/or nano-crystalline magnetic powders 136 are used in lieu of the amorphous magnetic powders and/or nano-crystalline magnetic powders 133. In this embodiment, a magnetic body material 16 comprising amorphous magnetic powders and/or nano-crystalline magnetic powders 136, which comprise at least partially oxidized amorphous magnetic powders and/or nano-crystalline magnetic powders formed of iron-based alloy and mechanically fused medium powders 132, insulating oxide powders 134 and silicon-free glass material 102, is produced. After a co-firing process, the magnetic body material 16 can be formed into a magnetic body, e.g., the magnetic body 1 shown in FIG. 1A.

It is to be noted that in the embodiments illustrated in FIG. 6 and FIG. 8, the amorphous magnetic powders and/or nano-crystalline magnetic powders may be spontaneously oxidized during the cofiring process with the silicon-free glass powders 102 instead of being additionally oxidized in advance.

In view of the foregoing, according to the present invention, an iron-based amorphous or microcrystalline magnetic material with low core loss may be used to form the multilayer magnetic body; heat treatment may be applied to the amorphous magnetic powders and/or nano-crystalline magnetic powders to produce oxide on the surface to achieve insulation effect; and the magnetic powders may be partially coated with at least one silicon-free glass by way of mechanical fusion. As a result, the silicon-free glass is distributed among the magnetic powders, and the magnetic powders are bonded by, for example, liquid-phase co-firing to obtain the required structural strength. Furthermore, an oxide layer produced on or added to the surface of magnetic powders can further increase the strength and insulation.

To sum up, when the magnetic powders in the entire magnetic body or in only the first portion 11 of the magnetic body comprise the mixed powders with at least two particle sizes and are bonded with the silicone-free glass material, as described above, high permeability, high mechanical strength and high insulating property can be exhibited. For example, the permeability can be increased by 25%, the mechanical strength can be increased by 62%, and the insulating property can be increased by 164%. In addition, when the spacing pattern layers 112 in the second portion 12 of the magnetic body 1 are made of magnetic powders of a single material and bonded with the silicone-free glass material, and if the average particle size (D₅₀) of the magnetic powders lies in a range of 1˜5 microns, the overall thickness of the magnet body or inductor can be effectively reduced. Furthermore, when oxides different from the magnetic powders are added and the powders are bonded with the silicon-free glass material, the insulating property can be adjusted or improved with proper oxides. For the application to a power inductor, it is preferred that the relative permeability is greater than 25, the insulation value is greater than 0.35 V/μm, and the high mechanical strength is greater than 15 MPa.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component adapted to be used in a power inductor, comprising:
a magnetic body comprising amorphous magnetic powders and/or nano-crystalline magnetic powders and at least one silicon-free glass material distributed among the amorphous magnetic powders and/or nano-crystalline magnetic powders;
a coil; and
a pair of electrodes electrically connected to two terminals of the coil, respectively.

2. The magnetic component according to claim 1, wherein the amorphous magnetic powders and/or nano-crystalline magnetic powders comprise at least a first diameter distribution peak at a first diameter and a second diameter distribution peak at a second diameter greater than the first diameter.

3. The magnetic component according to claim 2, wherein the first diameter is 1-2 μm, and the second diameter is 10-20 times of the first diameter.

4. The magnetic component according to claim 1, wherein the amorphous magnetic powders and/or nano-crystalline magnetic powders have an average particle size D₅₀ of 1-5 μm.

5. The magnetic component according to claim 1, wherein the coil comprises a plurality of wiring layers embedded in a first portion of the magnetic body, and a plurality of via layers embedded in a second portion of the magnetic body, and the first portion of the magnetic body and the second portion of the magnetic body are different in at least one parameter.

6. The magnetic component according to claim 5, wherein the amorphous magnetic powders and/or nano-crystalline magnetic powders contained in the first portion of the magnetic body have at least a first diameter distribution peak at a first diameter and a second diameter distribution peak at a second diameter greater than the first diameter.

7. The magnetic component according to claim 6, wherein the amorphous magnetic powders and/or nano-crystalline magnetic powders contained in the second portion of the magnetic body have a single diameter distribution peak at a third diameter.

8. The magnetic component according to claim 5, wherein an average particle size D₅₀ of the amorphous magnetic powders and/or nano-crystalline magnetic powders in the first portion of the magnetic body is greater than an average particle size D₅₀ of the amorphous magnetic powders and/or nano-crystalline magnetic powders in the second portion of the magnetic body.

9. The magnetic component according to claim 5, wherein the first portion of the magnetic body includes at least one first magnetic layer embedded therein one of the plurality of wiring layers, the second portion of the magnetic body includes at least one second magnetic layer embedded therein one of the plurality of via layers, and a thickness of the at least one first magnetic layer is greater than a thickness of the at least one second magnetic layer.

10. The magnetic component according to claim 9, wherein the thickness of the at least one second magnetic layer is less than 10 μm, and the thickness of the at least one first magnetic layer is 20-40 μm.

11. The magnetic component according to claim 1, wherein the magnetic body comprises at least two different materials of amorphous magnetic powders and/or nano-crystalline magnetic powders.

12. The magnetic component according to claim 1, wherein the magnetic body further comprises insulating oxide powders having an average particle size D₅₀ less than one tens of an average particle size D₅₀ of the amorphous magnetic powders and/or nano-crystalline magnetic powders.

13. The magnetic component according to claim 12, wherein the average particle size D₅₀ of the insulating oxide powders is less than 0.1 μm.

14. The magnetic component according to claim 1, wherein the magnetic body further comprises insulating oxide powders, which are oxidized from a material selected from a group consisting of magnesium, titanium, zinc, silicon and aluminum.

15. The magnetic component according to claim 1, wherein the magnetic body further comprises insulating oxide powders, and the insulating oxide powders in the magnetic body is equal to or less than 2.5 vol % of the amorphous magnetic powders and/or nano-crystalline magnetic powders in the magnetic body.

16. The magnetic component according to claim 1, wherein the amorphous magnetic powders and/or nano-crystalline magnetic powders comprises an oxide of a material of the amorphous magnetic powders and/or nano-crystalline magnetic powders.

17. The magnetic component according to claim 1, wherein the material of the amorphous magnetic powders and/or nano-crystalline magnetic powders comprises an alloy, which comprises elements Fe, Cr, Si, B and C.

18. The magnetic component according to claim 1, wherein the silicon-free glass material in the magnetic body is equal to or less than 8 vol % of the amorphous magnetic powders and/or nano-crystalline magnetic powders in the magnetic body.

19. The magnetic component according to claim 1, wherein the silicon-free glass material comprises SnO—P₂O₅, V₂O₅—TeO₂, Bi₂O₃—B₂O₃, ZnO, or A₂O—MoO₃, where A is an alkali metal or silver.

20. A fabrication method of a magnetic component, comprising:
forming a magnetic body comprising amorphous magnetic powders and/or nano-crystalline magnetic powders and at least one silicon-free glass material distributed among the amorphous magnetic powders and/or nano-crystalline magnetic powders;
forming a coil; and
forming a pair of electrodes electrically connected to two terminals of the coil, respectively.

21. The fabrication method according to claim 20, wherein the magnetic body is formed by:
processing a first mixture of the amorphous magnetic powders and/or nano-crystalline magnetic powders and the at least one silicon-free glass material into at least one first layer;
processing a second mixture of the amorphous magnetic powders and/or nano-crystalline magnetic powders and the at least one silicon-free glass material into at least one second layer; and
laminating the at least one first layer and the at least one second layer.

22. The fabrication method according to claim 21, wherein the coil is formed by:
embedding a wiring layer in the at least one first layer before laminating the at least one first layer and the at least one second layer; and
embedding a via layer in the at least one second layer before laminating the at least one first layer and the at least one second layer.

23. The fabrication method according to claim 22, wherein each of the first and second mixtures of the amorphous magnetic powders and/or nano-crystalline magnetic powders is processed by:
mechanically fusing glass powders or insulating oxide powders onto at least partial area of the amorphous magnetic powders and/or nano-crystalline magnetic powders; and
cofiring the amorphous magnetic powders and/or nano-crystalline magnetic powders, which are at least partially mechanically fused with the glass powders or insulating oxide powders, with the at least one silicon-free glass material.
